(19) United States
(12) Patent Application Publication
(10) Pub. No.: US 2022/0291916 A1
(43) Pub. Date: Sep. 15, 2022

(54) SERVER SYSTEM FOR UPDATING FIRMWARE WITH BASEBOARD MANAGEMENT CONTROLLER

(71) Applicants: INVENTEC (PUDONG) TECHNOLOGY CORPORATION, Shanghai (CN); INVENTEC CORPORATION, Taipei City (TW)

(72) Inventor: Ye LIU, Shanghai (CN)

(21) Appl. No.: 17/355,998

(22) Filed: Jun. 23, 2021

(30) Foreign Application Priority Data
Mar. 15, 2021 (CN) 202110275481.7

(51) Int. Cl. G06F 8/65; G06F 13/42

(52) U.S. Cl. CPC G06F 8/65; G06F 13/4282; G06F 2213/16

(57) ABSTRACT

A server system for updating firmware with a baseboard management controller (BMC) is disclosed, which includes the BMC, a first read-only memory (ROM), a second ROM, a first multiplexer (MUX), a second MUX, a third ROM, a fourth ROM, a smart network interface controller (NIC), a field programmable gate array (FPGA) chip and a complex programmable logic device (CPLD). The CPLD switches the first and second MUXs to allow the BMC to update firmware in the first, second, third or fourth ROM.

### CROSS-REFERENCES TO RELATED APPLICATION

This application claims the priority of Chinese patent application number 202110275481.7, filed on Mar. 15, 2021, the entire contents of which are incorporated herein by reference.

### TECHNICAL FIELD

The present invention relates to a system and, in particular, to a server system for updating firmware with a baseboard management controller (BMC).

### BACKGROUND

In general, a baseboard management controller (BMC) has four serial peripheral interface (SPI) buses, and a server system uses only one or two of them. In particular, one SPI bus may be coupled to a read-only memory (ROM) of the BMC itself in order to allow a read operation on, or an update of, firmware in the BMC, and another SPI bus may be coupled to an ROM of a central processing unit (CPU) in order to assist the CPU in reading or updating BIOS (Basic Input/Output System) firmware in the ROM.

However, with the development of technology, server systems are finding increasingly extensive uses and are evolving and improving to incorporate more and more ROMs and functional components for satisfying the requirements of different companies or users in various fields. There is therefore a need for improvements over the prior art.

### SUMMARY OF THE INVENTION

In view of the problems with the prior-art server systems arising from their use of only one or two serial peripheral interface (SPI) buses of a baseboard management controller (BMC), it is a principal objective of the present invention to provide a server system for updating firmware with a BMC, which solves at least one of the problems with the prior art.

To this end, the present invention provides a server system for updating firmware with a BMC, which includes a first read-only memory (ROM), a second ROM, a first multiplexer (MUX), a second MUX, a third ROM, a fourth ROM, a smart network interface controller (NIC), a field programmable gate array (FPGA) chip and a complex programmable logic device (CPLD).

The BMC has a first SPI bus and a second SPI bus. The first ROM is coupled to the BMC via the first SPI bus. The second ROM is coupled to the BMC via the first SPI bus. The first MUX is coupled to the BMC via the second SPI bus. The second MUX is coupled to the BMC via the second SPI bus. The third ROM is coupled to the first MUX. The fourth ROM is coupled to the second MUX. The smart NIC is coupled to both the first MUX and the BMC. The FPGA chip is coupled to both the second MUX and the BMC. The CPLD is coupled to both the first MUX and the second MUX.

The BMC is configured to be switched to be a master device for the second SPI bus in response to the issuance from the CPLD of a first switch signal to the first MUX or of a second switch signal to the second MUX so that it is able to update firmware in the third ROM by generating a first enable signal or to update firmware in the fourth ROM by generating a second enable signal.

Optionally, the server system may further include a third MUX, a fifth ROM, a sixth ROM and a central processing unit (CPU), the third MUX coupled to the BMC via a third SPI bus of the BMC, the fifth ROM coupled to the third MUX, the sixth ROM coupled to the third MUX, wherein the BMC is configured to be switched to be a master device for the third SPI bus in response to the issuance of a third switch signal from the CPLD to the third MUX so that it is able to update firmware in at least one of the fifth ROM and the sixth ROM.

The server system of the present invention is advantageous over the prior art in allowing the BMC to update firmware in six ROMs using its three SPI buses. In particular, upon a need for a firmware update in one of the first, second, third and fourth ROMs, the BMC is switched to be the master device for the SPI buses with the help of the first and second MUXs and the CPLD and is thus able to perform the required firmware update task. In addition, with the aid of the third MUX, the BMC is also allowed to update firmware in both the fifth and sixth ROMs in the CPU.

### BRIEF DESCRIPTION OF THE DRAWINGS

FIG. 1 is a block diagram of a server system for updating firmware with a baseboard management controller (BMC) according to a preferred embodiment of the present invention.

FIG. 2 schematically illustrates how the BMC interacts with first and second read-only memories (ROMs).

FIG. 3 schematically illustrates how a complex programmable logic device (CPLD) switches the BMC as a master device for a second serial peripheral interface (SPI) bus.

FIG. 4 is another schematic illustration of how the CPLD switches the BMC as a master device for the second SPI bus.

FIG. 5 schematically illustrates how the CPLD switches the BMC as a master device for a third SPI bus.

### LIST OF REFERENCE NUMERALS IN DRAWINGS

100 Server System for Performing Firmware Update with BMC;
11 BMC
12 First ROM
13 Second ROM
14 First MUX
15 Smart MC
16 Third ROM
17 Second MUX
18 FPGA chip
19 Fourth ROM
20 CPLD
21 Third MUX
22 CPU
23 Fifth ROM
24 Sixth ROM
CS0, CS1 Enable Signal
CS2 First Enable Signal
CS3 Second Enable Signal
CS4 Third Enable Signal
CS5 Fourth Enable Signal
S1 First Switch Signal
S2 Second Switch Signal
S3 Third Switch Signal

### DETAILED DESCRIPTION

Specific embodiments of the present invention will be described below in greater detail with reference to the appended schematic drawings. Features and advantages of the invention will be more readily apparent from the following detailed description, and from the appended claims. It is noted that the figures are presented in a very simplified form not necessarily drawn to exact scale for the only purpose of helping to explain the disclosed embodiments in a more convenient and clearer way.

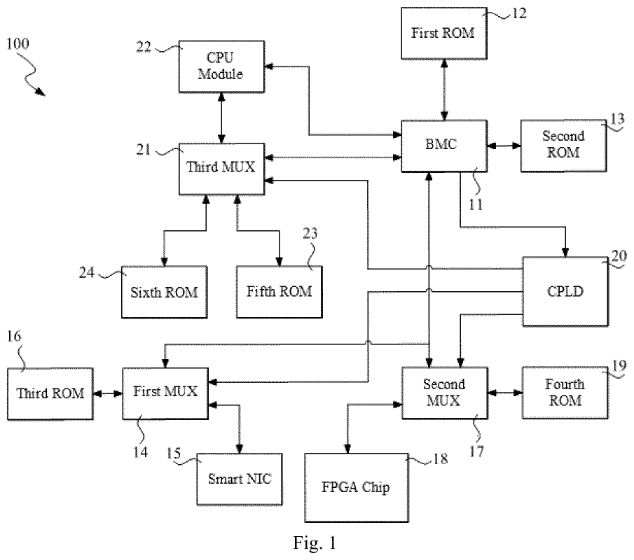

Reference is now made to FIG. 1, a block diagram of a server system for updating firmware with a baseboard management controller (BMC) according to a preferred embodiment of the present invention. As shown, the server system 100 includes the BMC 11, a first read-only memory (ROM) 12, a second ROM 13, a first multiplexer (MUX) 14, a smart network interface controller (NIC) 15, a third ROM 16, a second MUX 17, a field programmable gate array (FPGA) chip 18, a fourth ROM 19 and a complex programmable logic device (CPLD) 20.

In this embodiment, the server system 100 may further include a third MUX 21, a central processing unit (CPU) 22, a fifth ROM 23 and a sixth ROM 24.

The BMC 11 has a first serial peripheral interface (SPI) bus, a second SPI bus and a third SPI bus, and is coupled to the first and second ROMs 12, 13 via the first SPI bus, to the first and second MUXs 14, 17 via the second SPI bus, and to the third MUX 21 via the third SPI bus.

The first MUX 14 may be coupled to both the smart NIC 15 and the third ROM 16, the second MUX 17 may be coupled to both the FPGA chip 18 and the fourth ROM 19, and the third MUX 21 may be coupled to each of the CPU 22, the fifth ROM 23 and the sixth ROM 24.

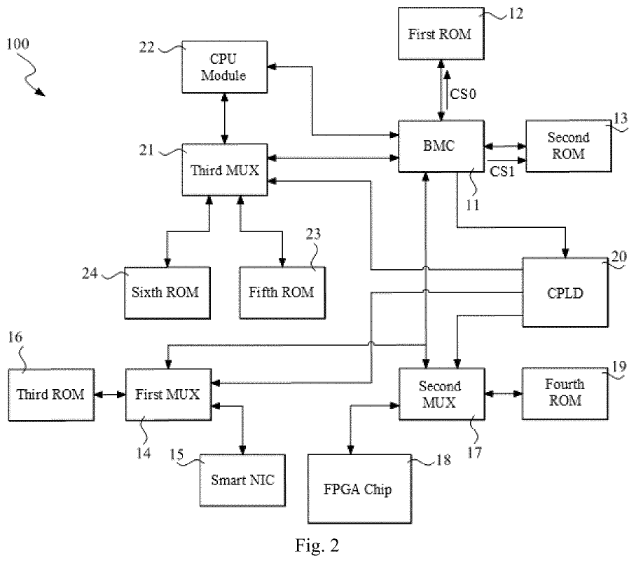

Reference is made again to FIG. 1, in combination with FIG. 2, a schematic illustration of how the BMC interacts with the first and second ROMs.

The first ROM 12 is generally configured to store the predefined BMC firmware. The second ROM 13 is configured to store the backup BMC firmware. The BMC 11 may read the predefined BMC firmware stored in the first ROM 12 with priority. When the BMC 11 cannot read the predefined BMC firmware readily, or when the read firmware cannot function normally, the backup BMC firmware in the second ROM 13 will be read instead. In this way, it will never be the case that the server system 100 is not able to operate normally due to only a single available copy of the firmware, which, however, becomes inoperable.

In addition, it will never be the case that the server system 100 is not able to operate normally due to storage of both the predefined BMC firmware and the backup BMC firmware in a single ROM, which, however, becomes inoperable.

As the BMC 11 is coupled to the first and second ROMs 12, 13 via the first SPI bus, enable signals (Chip Select (CS)) may be utilized to select the one of the first ROM 12 and the second ROM 13 that is to be read. In this embodiment, the first ROM 12 may be read under the action of an enable signal CS0 from the BMC 11. The second ROM 13 may be read under the action of an enable signal CS1 from the BMC 11.

In addition, the BMC 11 can directly update the predefined BMC firmware in the first ROM 12 or the backup BMC firmware in the second ROM 13 because it is a master device for all of the first SPI bus, the first ROM 12 and the second ROM 13. Similarly, the BMC 11 may utilize the enable signal CS0 or CS1 to accomplish the firmware update in the first ROM 12 or the second ROM 13, respectively.

It is to be noted that while separate lines are drawn in the figures between the BMC 11 and the respective first and second ROMs 12, 13 for the purpose of illustration, from the above description and common general knowledge in the art, those skilled in the art will appreciate that the BMC 11 is coupled to the first and second ROMs 12, 13 via the same first SPI bus.

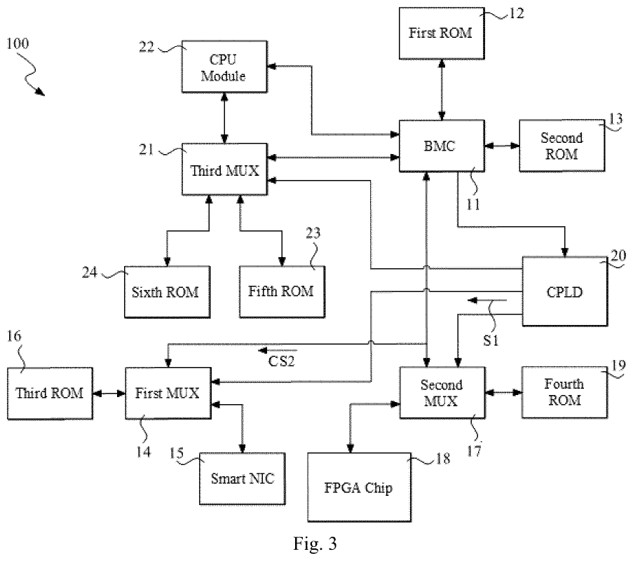

Reference is made again to FIG. 1, in combination with FIG. 3, which schematically illustrates how the CPLD switches the BMC as a master device for the second SPI bus. As shown, the BMC 11 is coupled to the first and second MUXs 14, 17 via the second SPI bus, and the CPLD 20 is electrically connected to the first MUX 14, the second MUX 17 and the BMC 11.

The third ROM 16 is configured to store smart NIC firmware. During normal operation of the server system 100, the smart NIC 15 is configured to read the smart NIC firmware from the third ROM 16 via the first MUX 14. That is, the smart MC 15 is a master device for the third ROM 16.

Upon a need to update the smart NIC firmware in the third ROM 16, the BMC 11 may instruct the CPLD 20 to generate a first switch signal S1 and transmit the first switch signal S1 to the first MUX 14. As a result, the BMC 11 may be switched to be the master device for the third ROM 16 and hence for the second SPI bus.

Since the BMC 11 is coupled to both the first and second MUXs 14, 17 via the second SPI bus, the BMC 11 may simultaneously issue a first enable signal CS2 to the first MUX 14, which allows the BMC 11 to perform the desired firmware update in the third ROM 16. Upon the completion of the smart NIC firmware update in the third ROM 16, the CPLD 20 may switch the master device for the third ROM 16 back to the smart NIC 15.

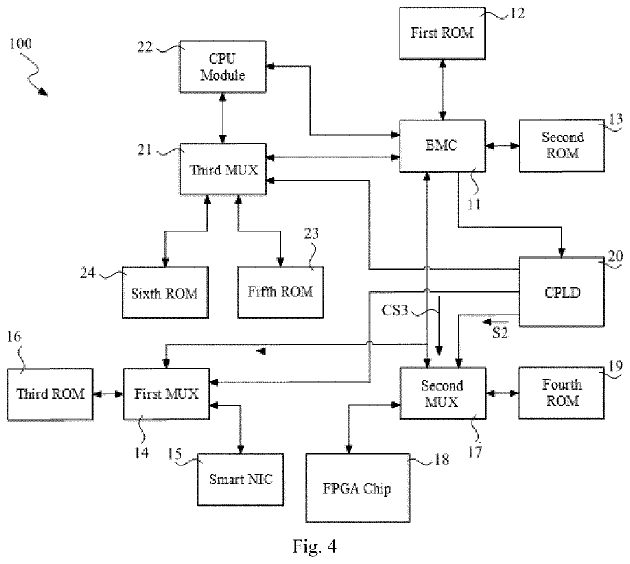

Reference is made again to FIG. 1, in combination with FIG. 4, another schematic illustration of how the CPLD switches the BMC as a master device for the second SPI bus. As shown, the BMC 11 is coupled to the second MUX 17 via the second SPI bus, and the CPLD 20 is electrically connected to both the second MUX 17 and the BMC 11.

The fourth ROM 19 is configured to store FPGA firmware. During normal operation of the server system 100, the FPGA chip 18 is configured to read the FPGA firmware from the fourth ROM 19 via the second MUX 17. That is, the FPGA chip 18 is a master device for the fourth ROM 19.

Upon a need to update the FPGA firmware in the fourth ROM 19, the BMC 11 may instruct the CPLD 20 to generate a second switch signal S2 and transmit the second switch signal S2 to the second MUX 17. As a result, the BMC 11 may be switched to be the master device for the fourth ROM 19 and hence for the second SPI bus.

Since the BMC 11 is coupled to both the first and second MUXs 14, 17 via the second SPI bus, the BMC 11 may simultaneously issue a second enable signal CS3 to the second MUX 17, which allows the BMC 11 to perform the desired firmware update in the fourth ROM 19. After the FPGA firmware update has been completed in the fourth ROM 19, the CPLD 20 may switch the master device for the fourth ROM 19 back to the FPGA chip 18.

Therefore, with the help of the first MUX 14, the second MUX 17, the CPLD 20, the first switch signal S1, the second switch signal S2, the first enable signal CS2 and the second enable signal CS3, the BMC 11 is able to update firmware (smart NIC firmware and FPGA firmware) in different ROMs (the third and fourth ROMs 16, 19) via a single SPI bus (the second SPI bus).

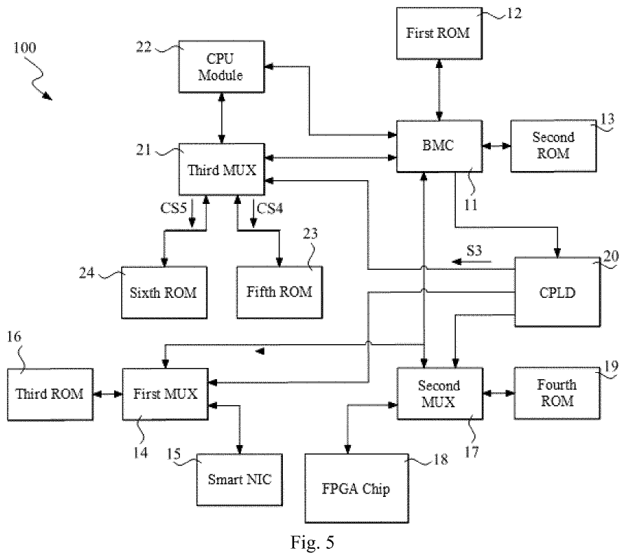

Reference is made again to FIG. 1, in combination with FIG. 5, a schematic illustration of how the CPLD switches the BMC as a master device for the third SPI bus. As shown, the BMC 11 is coupled to the third MUX 21 via the third SPI bus, and the CPLD 20 is electrically connected to both the third MUX 21 and the BMC 11.

The fifth ROM 23 is configured to store predefined BIOS firmware. The sixth ROM 24 is configured to store backup BIOS firmware. When the server system 100 is operating normally, the CPU 22 is configured to read the predefined BIOS firmware stored in the fifth ROM 23 via the third MUX 21 with priority. When the CPU 22 cannot read the predefined BIOS firmware readily, or when the read firmware cannot function normally, the backup BIOS firmware in the second ROM 13 will be read instead. In this way, it will never be the case that CPU 22 or even the whole server system 100 is not able to operate normally due to only a single available copy of the firmware, which, however, becomes inoperable. That is, the CPU 22 is a master device for both the fifth and sixth ROMs 23, 24.

When there is a need to update the predefined BIOS firmware in the fifth ROM 23 or the backup BIOS firmware in the sixth ROM 24, the BMC 11 may instruct the CPLD 20 to generate a third switch signal S3 and transmit the third switch signal S3 to the third MUX 21. Under the effect of the signal, the BMC 11 may be switched to be the master device for the fifth and sixth ROMs 23, 24 and hence for the third SPI bus.

As the BMC 11 is coupled to the third MUX 21 via the third SPI bus, enable signals (Chip Select (CS)) may be utilized to respectively allow the firmware update in the fifth or sixth ROM 23, 24. In this embodiment, the predefined BIOS firmware in the fifth ROM 23 is updated under the action of a third enable signal CS4 from the BMC 11. The backup BIOS firmware in the sixth ROM 24 may be updated under the action of a fourth enable signal CS5 from the BMC 11.

When the update of the predefined BIOS firmware in the fifth ROM 23 is completed, the CPLD 20 may switch the master device for the fifth ROM 23 back to the CPU 22. When the update of the backup BIOS firmware in the sixth ROM 24 is completed, the CPLD 20 may switch the master device for the sixth ROM 24 back to the CPU 22.

In summary, the server system of the present invention is advantageous over the prior art in allowing the BMC to update firmware in six ROMs using its three SPI buses. In particular, upon a need for a firmware update in any of the first, second, third and fourth ROMs, the BMC is switched to be the master device for the SPI buses with the help of the first and second MUXs and the CPLD and is thus able to perform the required firmware update task. In addition, with the aid of the third MUX, the BMC is also allowed to update firmware in both the fifth and sixth ROMs in the CPU.

The preferred embodiments as described in detail above are intended merely to more clearly explain the features and spirit of the present invention rather than to limit the scope thereof to these disclosed embodiments in any sense. On the contrary, it is intended that various changes and equivalent arrangements are also covered by the scope of the present invention as defined in the appended claims.

What is claimed is:

1. A server system for updating firmware with a baseboard management controller, comprising:
the baseboard management controller having a first serial peripheral interface bus and a second serial peripheral interface bus;
a first read-only memory coupled to the baseboard management controller via the first serial peripheral interface bus;
a second read-only memory coupled to the baseboard management controller via the first serial peripheral interface bus;
a first multiplexer coupled to the baseboard management controller via the second serial peripheral interface bus;
a second multiplexer coupled to the baseboard management controller via the second serial peripheral interface bus;
a third read-only memory coupled to the first multiplexer;
a fourth read-only memory coupled to the second multiplexer;
a smart network interface controller coupled to both the first multiplexer and the baseboard management controller;
a field programmable gate array chip coupled to both the second multiplexer and the baseboard management controller; and
a complex programmable logic device coupled to both the first multiplexer and the second multiplexer,
wherein the baseboard management controller is configured to be switched to be a master device for the second serial peripheral interface bus in response to issuance from the complex programmable logic device of a first switch signal to the first multiplexer or of a second switch signal to the second multiplexer so that the baseboard management controller is able to update firmware in the third read-only memory by generating a first enable signal or to update firmware in the fourth read-only memory by generating a second enable signal.

2. The server system according to claim 1, further comprising:
a third multiplexer coupled to the baseboard management controller via a third serial peripheral interface bus of the baseboard management controller;
a fifth read-only memory coupled to the third multiplexer;
a sixth read-only memory coupled to the third multiplexer; and
a central processing unit coupled to both the third multiplexer and the baseboard management controller,
wherein the baseboard management controller is configured to be switched to be a master device for the third serial peripheral interface bus in response to issuance of a third switch signal from the complex programmable logic device to the third multiplexer so that the baseboard management controller is able to update firmware in at least one of the fifth read-only memory and the sixth read-only memory.
